(19) United States
(12) Patent Application Publication
(10) Pub. No.: US 2005/0021868 A1
(43) Pub. Date: Jan. 27, 2005

(54) Communications server method & apparatus for transacting voice, text, video and graphical data communication sessions from both wireless and wire-line networks

(76) Inventors: Vijay K. Sharma, Morgan Hill, CA (US); Mark Jensen, Morgan Hill, CA (US)

Correspondence Address: Vijay K. Sharma;Merge Networks, Inc., 105 Cochrane Circle, Morgan Hill, CA, 95037, US

(21) Appl. No.: 10/609,761

(22) Filed: Jul. 1, 2003

(51) Int. Cl. G06F 15/16

(52) U.S. Cl. 709/249; 709/250

(57) ABSTRACT

The method and apparatus of the present invention discloses a communications server that may be simultaneously connected to and conversant with a plurality of wire-lined and wireless networks. The communications server of the present invention includes, among other things, a central processing unit, a network interface unit, and a memory to direct the operations of the server in such a way that communications sessions may be established between one or more users and one or more of the plurality of wire-lined or wireless networks. In a preferred embodiment, the communications sessions may be transacted between a variety of communication devices including a multi-mode wireless phone which identifies itself to the communications server and indicates to the communication server which of the plurality of wire-lined or wireless networks is to be used for a particular communications session.

This non-provisional patent application is related to provisional patent application 60/392,621 filed on Jun. 28, 2002.

### BRIEF DESCRIPTION

The subject of this invention relates to the communications industry. Specifically, this invention concerns a communications server capable of transacting voice, text and graphical data communications sessions with a variety of wireless and wire-lined communications devices over a plurality of both wire-lined and wireless networks.

### BACKGROUND OF THE INVENTION

Humans have needed to communicate over distances for all of history. Over that history the methods used have improved, but the object is the same: send and receive information. Early man undoubtedly used numerous methods including shouting and smoke. Later, for example during the time Roman Empire was using its armies to expand over most of Europe, flag signals were used to control movements of troops. These methods remained essentially unchanged until the early part of the 19^{th} century.

Of course modern communications are based on electricity. In 1825, British inventor William Sturgeon demonstrated the electro-magnet, laying the foundation for large scale electronic communication. Then, in 1830, the American Joseph Henry demonstrated the first telegraph by sending a signal over a mile of wire. But it wasn't until 1843 that a publicly funded stretch of 40 miles of wire from Washington D.C. to Baltimore operating the Morse Code proved that a telegraph system could work.

The telegraph became the main form of distance communication, including a trans Atlantic cable. Wires ran across the continent along rail corridors, providing rapid and reliable communication from very distant parts of the nation. But in 1875 Alexander Graham Bell demonstrated the first device that was capable of passing voice data over a wire. With the birth of the telephone, electronic communication rapidly expanded into homes and offices.

The Public Switched Telephone Network, or PSTN, as we know it today was the result of the continuous improvement in devices and expansion of the wire-lined network. But in the 1930s mostly as a result of the need for rapid, remote and wireless battlefield communications, the radio-telephone began to emerge. The earliest versions were truly radios, but as time passed and the emergence of the semiconductor allowed extreme size and weight reductions, the devices became smaller and less expensive. Again propelled by technological advances including increases in frequencies and deployment of remote relay stations, the modern cell phone network appeared.

Current developments in the communications industry include the merging of technologies. For example, cell phones, computers, PDAs and intelligent remote reporting devices such as electric meters are all beginning to have similar capabilities. Laptop computers are capable of connecting to local wireless networks via the 802.11 wireless standard as well as connecting to the Internet via the cell phone network or a land line. As these technologies continue to merge, they are also becoming cross functional. Cell phones now have the ability to browse the Internet and receive video data as well as voice communications.

But as these technologies advance and merge, integration remains a problem. Thus if a user wishes to make a cell phone call he or she must use a cell phone. Likewise, if that same user wishes to continue the cell phone call but has a need to leave an environment where the cell signal is sufficient, they must either hang up and reconnect using a land line phone or must simply let the call drop. What is needed is a method and apparatus that provides a plurality of connectivity modes and that can seamlessly move between these modes without dropping a communications session in progress. The method and apparatus of the present invention accomplish this and other goals and objectives described below in detail.

### SUMMARY OF THE INVENTION

The method and apparatus of the present invention discloses a communications server that may be simultaneously connected to and conversant with a plurality of wire-lined and wireless networks. The communications server of the present invention includes, among other things, a central processing unit, a network interface unit, and a memory to direct the operations of the server in such a way that communications sessions may be established between one or more users and one or more of the plurality of wire-lined or wireless networks. In a preferred embodiment, the communications sessions may be transacted between a variety of communication devices including a multi-mode wireless phone which identifies itself to the communications server and indicates to the communication server which of the plurality of wire-lined or wireless networks is to be used for a particular communications session.

In operation the communications server of the present invention uses a presence manager module, residing in memory and containing certain software instructions, to maintain a table of user devices reachable by the plurality of networks connected to the server. The characteristics of each of the user devices are maintained in a personal profile and call manager module so that the server may determine the protocol to be used for a particular device and communications session. Other operational modules include a directory services module, a messaging services manager module, an administration and system functions module, a media processing module and a network interface manager module, each operably connected in such a way as to cause the communications server of the present invention to establish a communication session between a user device and one of the plurality of wire-lined or wireless networks in response to a request, either from the user device or from a remote device seeking to contact a user device.

The request to establish a communications session may be either internal or external. The internal request, in the form of a data “push,” results form the need to pass such information as system status or registered users to one or more devices registered with the system. An external request would be a user wishing to originate a session. Advantageously, the method and apparatus of the present invention are capable of managing communications with both contemporary, network enabled telephony equipments as well as older, so called legacy equipments.

### BRIEF DESCRIPTION OF THE DRAWINGS

FIG. 1: shows a diagram of a system that can make use of the method of the present invention.

FIG. 2: provides a detailed block diagram of a communications server that can be used with the method of the present invention.

FIG. 3A: shows an overall state diagram of the communications server process that can make use of the method of the present invention.

FIG. 3B: shows details of the System Administration state of the communications server process used in one. embodiment of the present invention.

FIG. 3C: shows details of the Acquisition state of the communications server process used in one embodiment of the present invention.

FIG. 3D: shows details of the Call Management state of the communications server process used in one embodiment of the present invention.

FIG. 3E: shows details of the Error state of the communications server process used in one embodiment of the present invention.

### DETAILED DESCRIPTION OF PREFERRED EMBODIMENTS

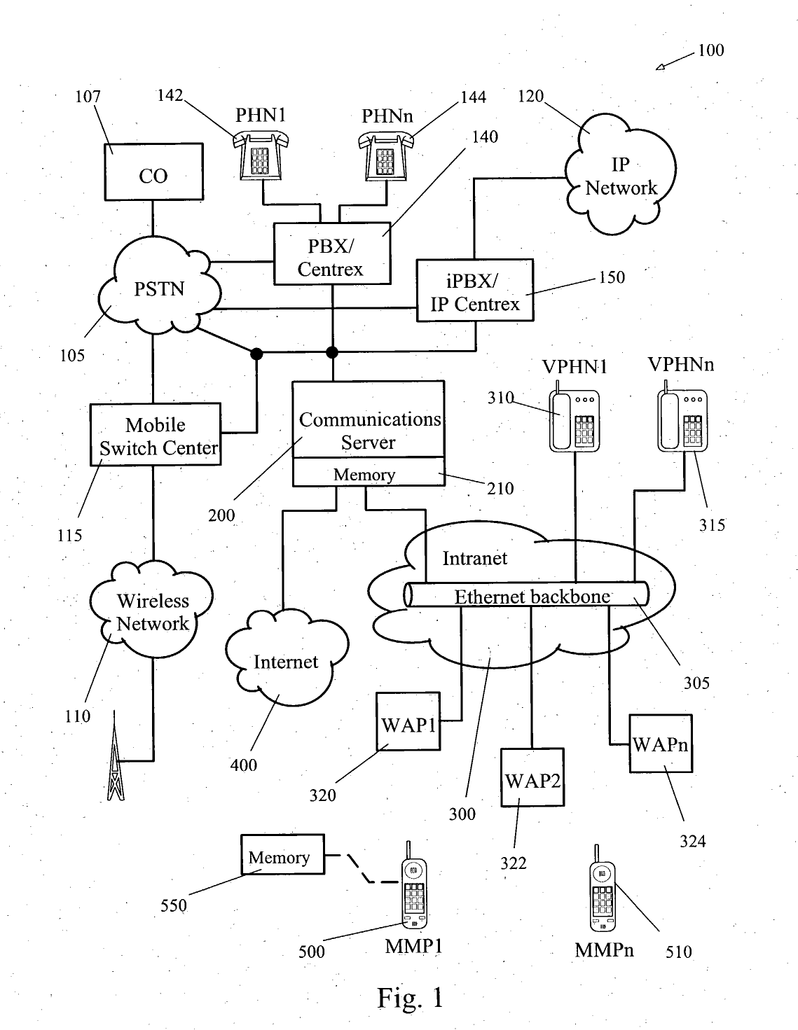

FIG. 1 presents a system 100 showing a preferred embodiment of the present invention. A Communications Server 200 is connected to a plurality of networks including Intranet 300, Internet 400, IP Network 120, Public Switched Telephone Network [PSTN] 105, and Wireless Network 110. Communications Server 200 connects to the PSTN 105 either directly, or via PBX/Centrex 140, and from the PSTN 105 to the Central Office [CO] 107. The Communications Server 200 also connects to Wireless Network 110 either via PSTN 105 or directly to the Mobile Switching Center 115. Each of these connections is made in the customary manner and thus is not discussed in detail to aid in clarity. Also connected to the Communications Server 200 via PBX/Centrex 140 are a plurality of Customer Premises Equipments [CPE] PHN1 142 through PHNn 144. The PBX/Centrex 140 and CPEs PHN1 142 through PHNn 144 are so called legacy equipments because they employ older technology. However, since these devices are still in wide use, the method of the present invention advantageously accommodates these legacy equipments.

IP Network 120 connects to the Communications Server 200 via iPBX/IP Centrex 150. The iPBX/IP Centrex 150 is the modern equivalent of the legacy equipments discussed above. These newer Private Branch Exchanges [PBX] offer a broader range of services to users, for example, Voice Over IP [VOIP]. iPBX/IP Centrex 150 also connects directly to the PSTN 105 as was the case for the legacy PBX above. The method and apparatus of the present invention offers the advantage of connecting to both modern and legacy systems.

Still referring to FIG. 1, and looking more closely at Intranet 300, in a preferred embodiment of the present invention an Ethernet backbone 305 is used to provide the protocol for passing data communications between devices attached to the network. While the method of the present invention uses an Ethernet protocol, this is not the only protocol that could be used, thus this should not be read as a limitation on the scope of the invention.

Also connected to the Ethernet backbone 305 are a plurality of Internet compliant telephones VPHN1 310 through VPHNn 315. These so called iPhones have the ability to display text and graphics as well the customary voice services of a standard telephone. As described in greater detail below, the Communications Server 200, via its internal Memory 210, has the ability to manage communications sessions between the iPhones VPHN1 310 through VPHNn 315 and other communications devices including both wire-lined and wireless devices.

In a preferred embodiment of the present invention Intranet 300 is a Local Area Network [LAN], for example, a network confined to the area within a business. Wireless Access Points WAP1 320, WAP2 322 and WAPn 324 are attached to the Ethernet backbone 305 in the customary manner. Upon receiving low power radio communications from a compatible wireless device, the wireless access points WAP1 320, WAP2 322 and WAPn 324 transfer the data to the Communications Server 200 for processing. Conversely, data from the Communications Server 200 may be sent to compatible wireless devices via Wireless access points WAP1 320, WAP2 322 and WAPn 324. In a preferred embodiment, the wireless network uses the 802.11 communications standard, but this is not the only wireless standard that may make use of the method of the present invention, thus use of this standard should not be read as a limitation on the scope of the invention.

Further, while in the preferred embodiment the Intranet 300 is confined to a business, there are other applications, for example, at airports, that could make use of the method of the present invention, thus use inside a business should not be read as a limitation on the scope of the invention. And while in the preferred embodiment the PBX/Centrex 140 and the iPBX/Centrex 150 are standalone devices, there is no reason that the functions of these devices could not be integrated into the Communications Server 200 architecture, providing both space and efficiency gains.

For the method of the present invention, one preferred wireless device is a single user communications device such as MMP1 500 through MMPn 510. In a preferred embodiment of the present invention, MMP1 500 through MMPn 510 are multi-mode wireless communications devices. As such, these devices continually scan known wireless protocols seeking presence of compatible signals. Upon finding a compatible signal, the strength of that signal is stored in memory and continuously updated for future reference and then the scan continues. In this way, MMP1 500 through MMPn 510 are constantly aware of the best signal to be used at any given point in time. Information about the strength of various signals as well as other data and programming code are maintained in Memory 550 within each of the MMP devices. Note that while the single user device discussed in conjunction with the method of the present invention is a multi-mode phone, other devices could be used without departing form the spirit of the invention, for example, PDA, laptop computers, or data entry devices such as point-of-sale [POS] terminals.

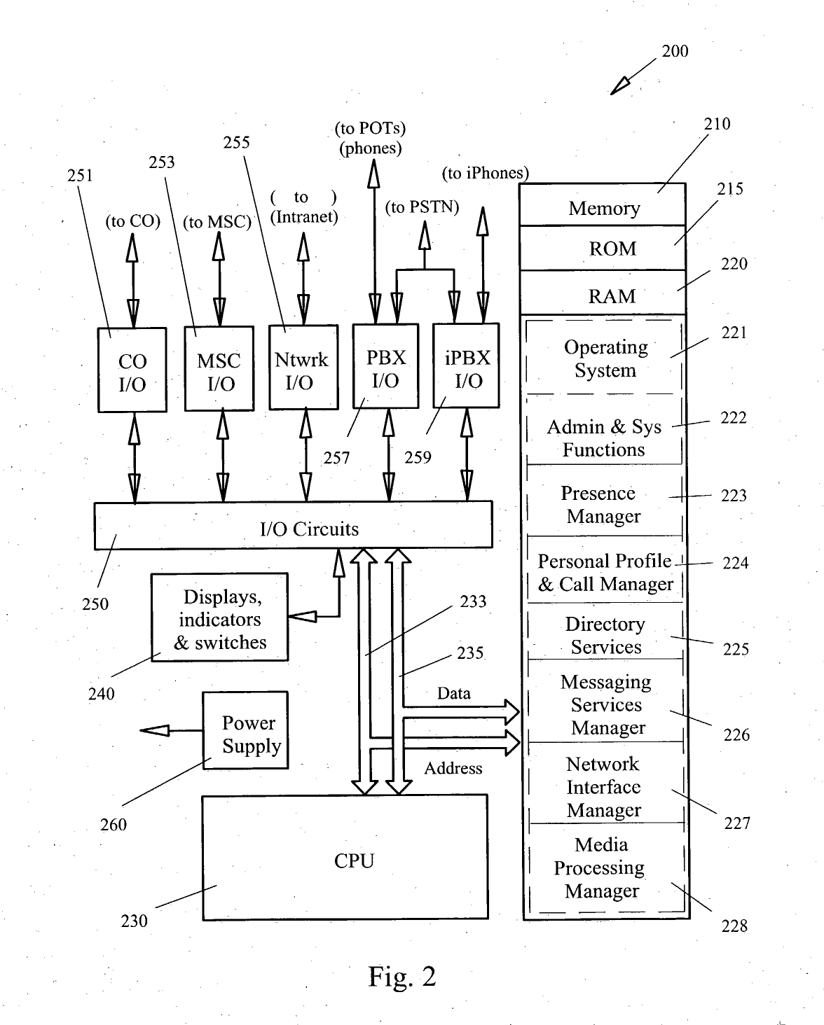

Looking now at FIG. 2, a detailed block diagram of the Communications Server 200 is shown. Communications Server 200 may be any contemporary server capable of communicating with multiple I/O channels. CPU 230 connects to Memory 210 and I/O Circuits 250 via data and address buses 233 and 235 respectively in the customary manner. A plurality of I/O channels, typically in the form of pluggable cards, are used at the output of I/O Circuits 250 to interface with the various networks. By way of example, but not meant as a limitation, CO I/O 251 interfaces with the CO (107 in FIG. 1) via the PSTN, MSC I/O 253 interfaces with the mobile switching center (115 in FIG. 1), Ntwrk I/O 255 interfaces with the Intranet 300 in FIG. 1, PBX I/O 257 interfaces with the phones and PSTN and iPBX I/O 259 interfaces with iPhones and the PSTN, all shown in FIG. 1.

Display, indicators & switches 240 accomplishes the functions associated with devices customary in the art. Power Supply 260 functions to provide the multiple levels of voltage and current needed to operate a communications server, and may include battery backup to prevent loss of operation in a power out situation. In the preferred embodiment, the Communications Server 200 is based on a compact Peripheral Component Interconnect [cPCI] chassis from Elma Electronic Inc. of Fremont, Calif., and uses cPCI board assemblies from both Trident Infosol of Bangalore, India and Concurrent Technologies Inc. of Ann Arbor, Mich., but as will be understood, other server and/or board combinations could be used without departing from the spirit of the invention.

Continuing to look at FIG. 2, Memory 210 is comprised of RAM 220, ROM 215, Operating System 221, and software function modules 222 through 228. RAM 220, ROM 215 and Operating System 221 perform functions well understood in the art thus are not treated in detail to aid in clarity. In the preferred embodiment, the Operating System 221 is Windows NT from Microsoft in Redmond, WA. Each of the software function modules 222 through 228 are discussed generally just below and in detail in conjunction with FIGS. 4A through 4E. Note that such data as housekeeping program modules, user programmable data and other data normally associated with a digital server device are not shown since they do not directly impinge on the method of the present invention. However, as these modules are customary, their absence should not be read as a limitation on the scope of the invention.

Admin & Sys Function module 222 is responsible for system initialization, session data logging, and management of all the other functions of the Communications Server 200. As such it manages the Directory, the Activity Log and other functions needed to maintain orderly operation.

The Presence Manager module 223 contained within Memory 210 performs two main functions: recognition of which WAP should be used for a given communications session with a wireless communication device and coordination of the transactions between the public cellular network and the Intranet 300, particularly, implementing the seamless handoff for active communications sessions. The recognition function is needed since, as shown in FIG. 1, many WAPs are connected to the Intranet 300. A wireless communication device, being portable, could possibly be in closer proximity to one WAP as opposed to another. Since this is true, the strength of the signal over the closer WAP would be desirable for a communications session due to the inherently greater reliability of a stronger signal. The purpose of the recognition function is to determine which of the WAPs connected to the Intranet 300 and the target wireless device has the best signal and is thus best suited to transact data with the Communications Server 200. This includes dynamic assignment of DHCP [Dynamic Host Control Protocol] sub-net addresses allowing seamless transition from one sub-net to another.

Assume, for example, that an incoming call to MMPn 510 in FIG. 1 has been detected. Further assume that the user of MMPn 510 is located closest to WAP2 322. Based upon preconfigured signal strength limits, the recognition function of the Presence Manager module 223 will direct traffic to MMPn 510 via WAP2 322. Should the user transit from one area to another where a different sub-net will provide superior communications session support, a new DHCP address will be assigned and the session seamlessly transferred without the user's knowledge.

The coordination function of the Presence Manager module 223 operates to coordinate data transactions between the Intranet 300 and the public cellular telephone network. This is accomplished using the standard signaling techniques employed by the public cellular telephone network. By way of example, suppose that the same incoming call to MMPn 510 from above was received while the user was on the way to the office using the PCM protocol. During this time the communications session transits the normal public cellular telephone network. Upon arriving at the office, MMPn 510 signals the Communications Server 200 that it is present and is registered. The Presence Manager module 223 then compares the viability of the PCS signal versus the 802.11 signal from the closest WAP. Finding that the 802.11 signal is superior, the coordination function operates to switch the communications session from the PCS signal to the 802.11 signal. This transition occurs using standard cellular telephone network signaling and is invisible to the user.

The Personal Profile & Call Manager module 224 contained within Memory 210 is responsible for numerous activities related to the control of the MMP devices present on the Intranet 300. Included are creating and editing user profiles for each of the MMPs using the network, creating and editing call handling characteristics based on area code, caller ID, time of day, and location, among others. Also included within the Personal Profile & Call Manager module 224 are the ability to create and edit call disposition profiles that automatically select such functions as speed dialing or automatic redirect to an alternative telephony device such as a CPE. A web browser user interface is provided to allow access to the module to permit the settings of user and administrator access levels through a PC [Personal Computer.]

The Network Interface Manager module 227, contained within Memory 210, provides the necessary functions to coordinate between the Intranet 300 and other network connected devices such as PBX 110 and iPBX 120. As noted previously, communications sessions active over one or more WAPS use the 802.11 protocol in a preferred embodiment of the present invention. The Network Interface Manager 227 assists in translation of this protocol to that used by the external devices. A library of external device protocols is maintained such that an incoming call received by iPBX 150 and directed to VPHN1 310, for example, may be redirected to MMPn 510 by the Personal Profile & Call Manager module 224. This will occur if the user of VPHN1 310 has programmed such a redirection. The Network Interface Manager 227 translates the incoming iPBX protocol to the 802.11 protocol understood by the MMP. In this way, the method of the present invention enables a single user communications device to be programmed to receive calls from a plurality of separate communications devices, thereby greatly improving the efficiency of the communications process by providing a single contact device for a given user.

Further, the Network Interface Manager module 227 works in concert with Messaging Services Manager module 226 and Presence Manager module 223 to provide the correct network protocol for each instance of a communication session. Since a broad spectrum of communications devices may be attached to and using the available I/O channels, the Network Interface Manager module 227 ensures that the proper protocols for the target network and communication device are active on that channel. For example, suppose that a user initiates a call on a cell phone at a time when the 802.11 wireless network is the most advantageous. The Network Interface Manager module will work with the Messaging Services Manager module 226 and Presence Manager module 223 to assure that the outgoing data is formatted properly for the wireless cellular network.

Directory Services module 225 contains the necessary software instructions to create, update, and service requests for information related to users attached to the system. This information includes, but is not limited to, individual target device types, numbers, addresses and related format data as well as other user data base records. As well, group addresses and identities are created and stored by this module. Messaging Services Manager module 226 operates in coordination with the Personal Profile & Call Manager module 224 and the Directory Services module 225 to select the correct set of interfaces for a particular instance of a communications session. By way of example, a user registered with the system and using a cell phone may wish to contact another user on an 802.11 device, for example, a PDA (Personal Digital Assistant). Messaging Services Manager module 226 will use the data in the Directory Services module 225 and the Personal Profile & Call Manager module 224 to determine the appropriate set of interfaces needed to convert the source device data to the format needed by the destination device.

Media Processing Manager module 228 is responsible for determining what types of data a particular communications device can receive. If a user receives a call from a video capable device, for example, a cell phone with a camera, but the user answers on a standard CPE device, no video image can be received. The Media Processing Manager module 228 uses the Personal Profile & Call Manager module 224 and the Messaging Services Manager module 226 to assist in making the proper determination.

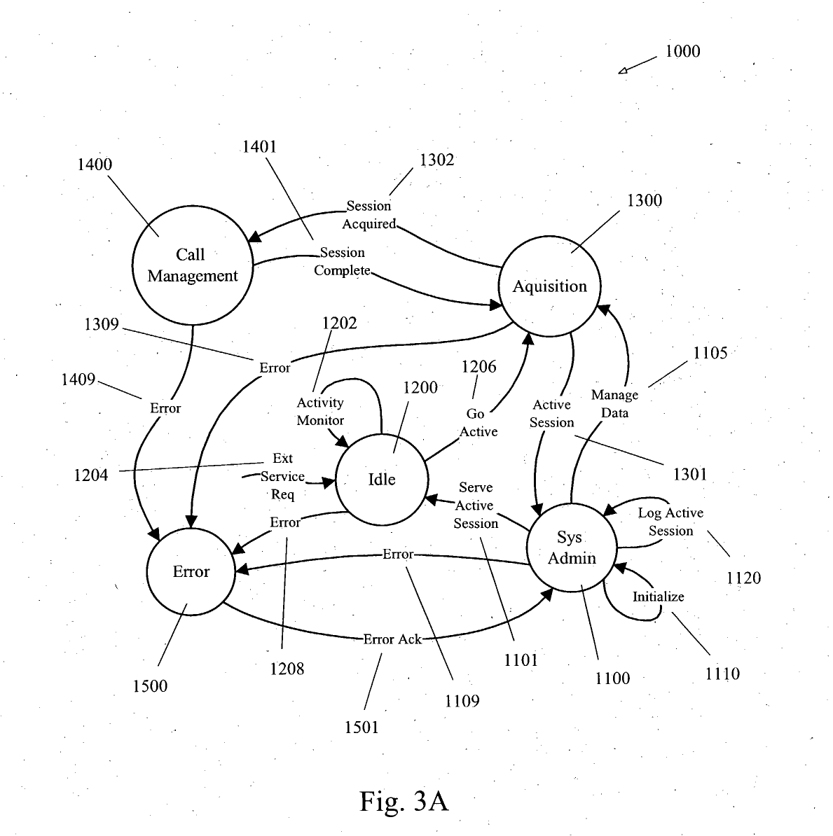

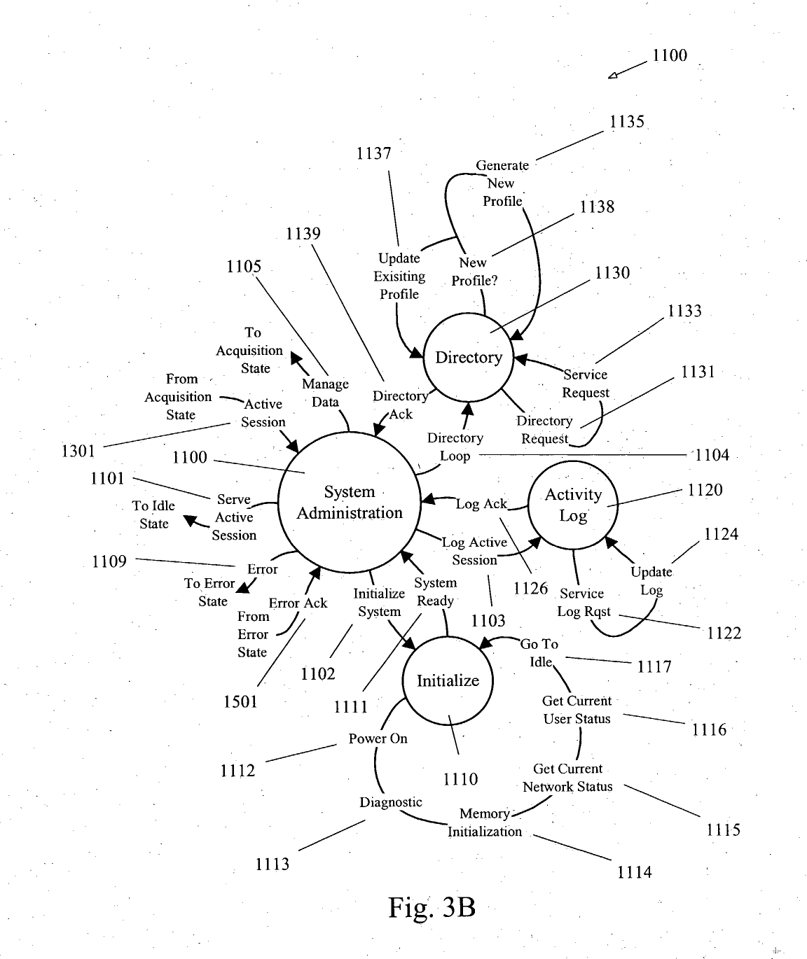

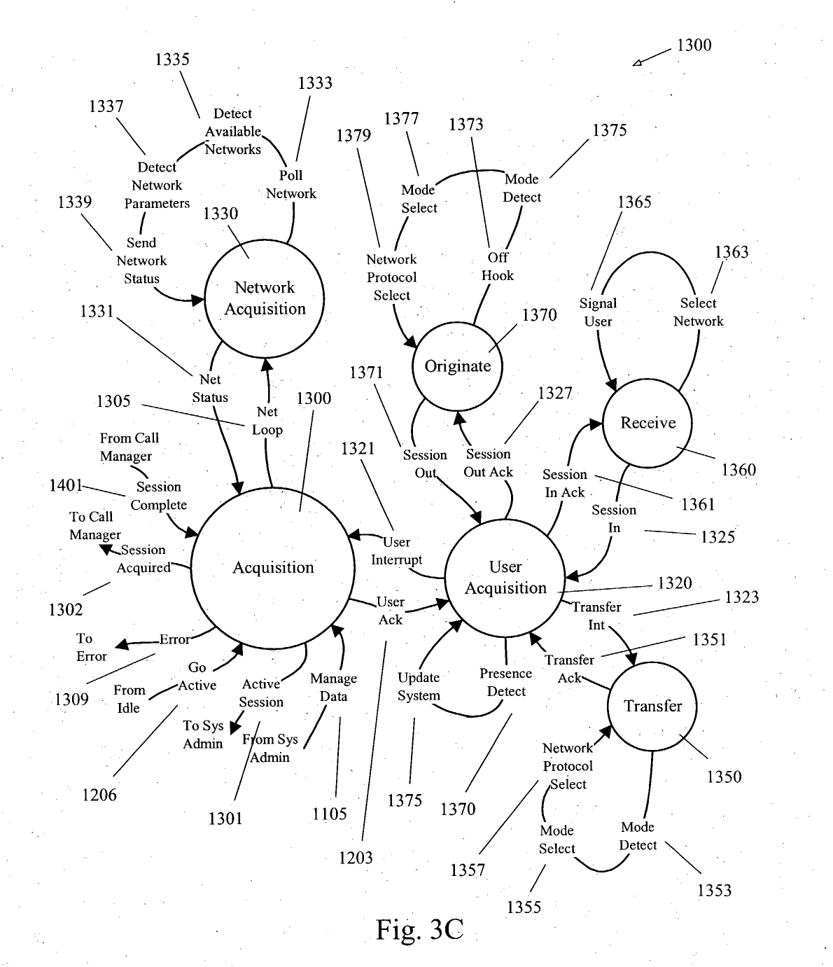

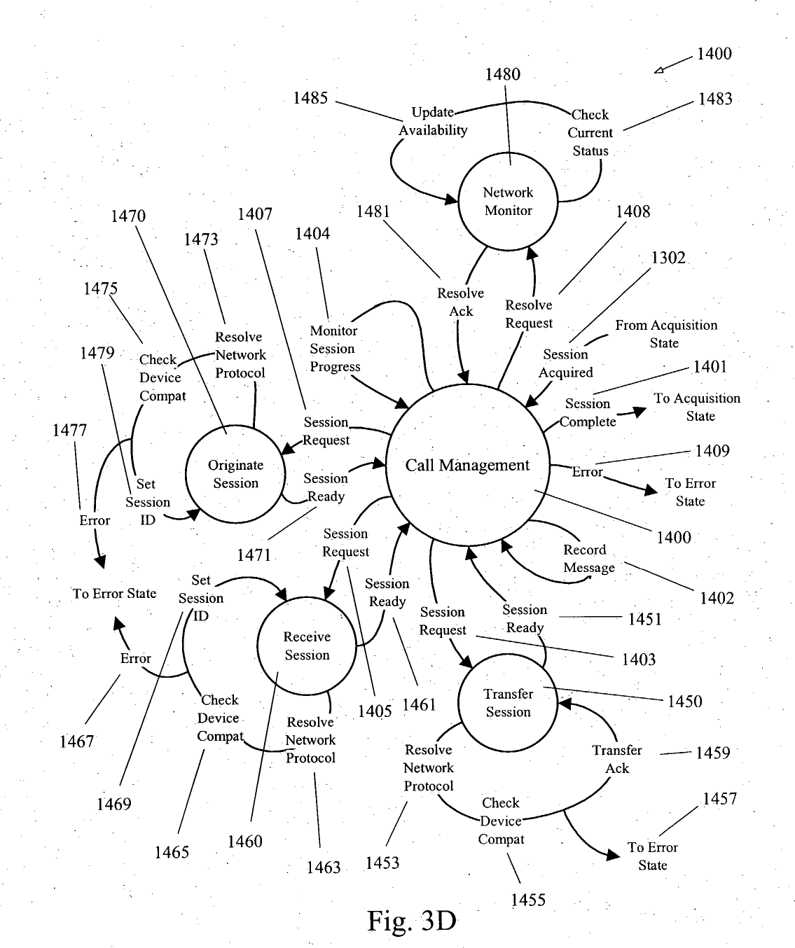

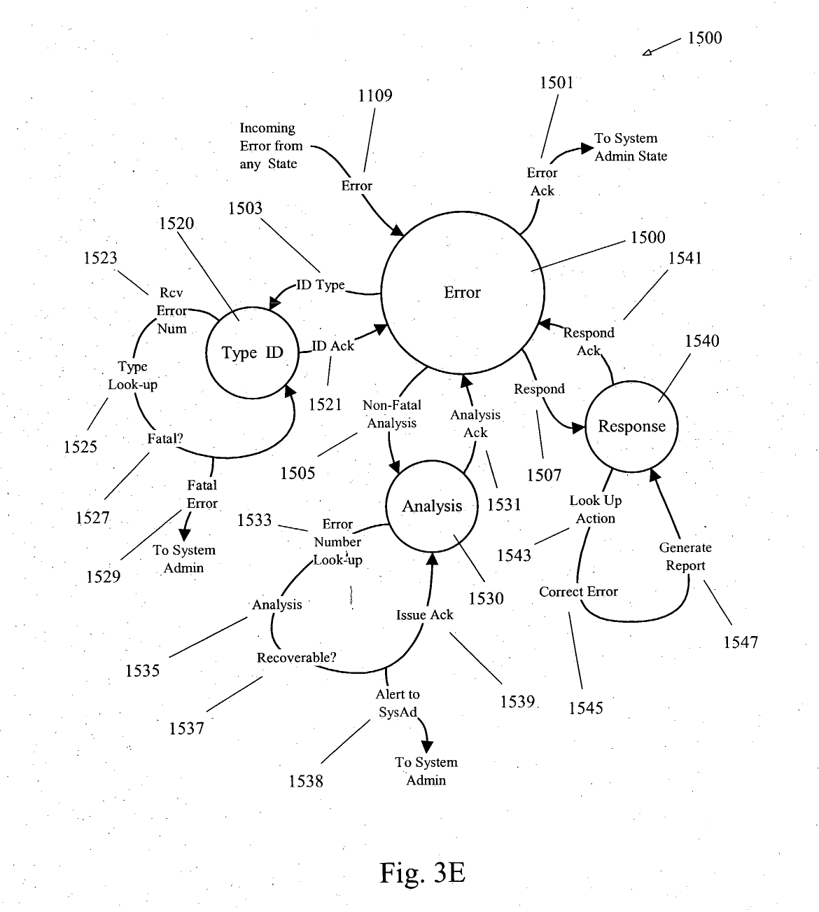

Because the operation of the system is distributed among several major components, of which the Communications Server 200 is just one, an operational discussion of the method of the present invention is best handled by a series of state diagrams. FIGS. 3A through 3E present the operational details of the Communications Server 200 of FIG. 1. It will be understood that although the figures are discussed separately, taken together the diagrams implement the software program modules of FIG. 2 and are constantly interacting to accomplish execution of communications sessions. Thus discussion of these figures separately does not imply that each operates in isolation. Further, while the following discussion presents one operational scenario, it will be recognized that many operational scenarios are possible and that the collective software program will react differently to these differing scenarios without departing from the spirit of the invention.

Looking first at FIG. 3A, an overall state diagram 1000 of the Communications Server 200 is shown. Operation begins with the Sys Admin state 1 100 when power is applied to the server. The various components of the server related hardware and software are made ready at Initialize 1110. This initialization process is described in greater detail below. Once the initialization is complete the process advances to the Idle state 1200 via the Serve Active Session interrupt 1101. The system will remain in this state until some outside activity triggers the server into action. Ext Service Req 1204 is such an activity. This might occur, for example, if a user originates a call or if an incoming call to a user was received by a communications device registered with the server. Such external service requests as Ext Service Req 1204 are detected by Activity Monitor 1202. Activity Monitor 1202 is a program loop that constantly surveys the available networks and attached devices looking for service request interrupts.

Once a service request has been received by the Idle state 1200, a Go Active signal 1206 is sent to the Acquisition state 1300. This signal indicates to the system that some sort of user activity has been requested. If, at any time, the Idle state 1200 detects an error, the Error signal 1208 causes control of the process to pass to the Error state 1500, discussed in detail below. In a like manner, if the Sys Admin state 1100 detected an error, the Error signal 1109 accomplishes the same thing. Once an active session has been acquired, as described below, the Sys Admin state 1100 informs the Idle state 1200 via the Serve Active session signal 1101 that the session is being served and to continue monitoring for additional activity via the Activity Monitor loop 1202.

The Acquisition state 1300, described in detail below, executes the software programs needed to support connection to the various wire-lined and wireless networks attached to the system.

The Acquisition state 1300 is entered via the Go Active Signal 1206. The Acquisition state 1300 then acquires the session and passes control to the Call Management state 1400 via the Session Acquired signal 1302. Recall from above that the Personal Profile & Call Manager software module (224 in FIG. 2) creates and tracks the users attached to the Communications Server 200. In the Call Management state 1400 these data are used to determine how any given user and session are to be handled.

Once the session is complete the Call Management state 1400 return the process control to the Acquisition state 1300 via Session Complete signal 1401. In turn, the Acquisition state 1300 transfers the process back to the Sys Admin state 1100 via the Active Session signal 1301. At any time a new session becomes active, the Log Active Session routine 1120 creates and tracks that session's activity. During any particular session certain data and state interactions are required.

Thus the Manage Data signal 1105 from the Sys Admin state 1100 to the Acquisition state 1300 is used to pass process control when needed. Note that the above explanation appears to be very linear, however, as will be recognized, there are many different combinations of circumstances that will cause the various states to interact differently. The above explanation is meant as an example only, thus should not be read as a limitation on the scope of the method of the present invention.

As was the case for the Sys Admin state 1100, both the Acquisition state 1300 and the Call Management state 1400 provide an error path to the Error state 1500 via Error signals 1309 and 1409 respectively. The Error state 1500, described in detail below, receives an error signal, analyzes the error and makes some determination about how the system must react. Whatever the decision, the Error state 1500 informs the Sys Admin state 1100 via the Error Ack signal 1501.

FIG. 3B provides the details of the System Administration state 1100. While it will be understood that the Sys Admin state 1100 accomplishes a plethora of tasks, the three main functions related to this state are initialization, activity logging and directory services. Recalling from FIG. 3A that once power has been applied a power on indication occurs and the process passes to the Initialize state 1110 via the Initialize System signal 1102. In response, the Initialize state 1110 sends a Power On signal 1112 to the rest of the system and launches a series of diagnostic tests to assure that the system components are in operating order via the Diagnostic routine 1113. Upon completion of the diagnostic tests the Memory Initializations signal 1114 causes the various areas of memory to be reset. As is known to those in the art, this includes setting of all variables to their initial condition, loading the program modules into their proper memory locations, and starting the main program.

Once the bootstrap process is completed the system polls the various network interfaces to determine the current status of the networks attached to the Communications Server 200 via the Get Current Network Status signal 1115. The status of the networks is stored in the appropriate memory locations followed by a polling of the current users attached to the server via the Get Current User Status signal 1116. As with the network status, this information is stored in memory for later use by the system. At this point in time the system is ready for normal operations so the process returns to the Initialize state 1110 via the Go To Idle signal 1117 and from there to the Sys Admin state 1100 via the System Ready signal 1111. As discussed above, the process then goes to the Idle state 1200 via the Serve Active Session signal 1101 where normal operation commences.

The Activity Log state 1120 is entered when the system requests an activity log update via the Log Active Session signal 1103. The request is serviced at Service Log Rqst 1122, the log updated at Update Log 1124 and the process returned to the Sys Admin state 1100 via the Log Ack signal 1126. The Directory state 1130 is entered when a directory service request is received via the Directory Loop signal 1104. Once in the Directory state 1130 there are several tasks that may be accomplished. If the request is for a data record the Directory Request signal 1131 causes a directory lookup to occur via the Service Request signal 1133. Once the data has been fetched the Directory Ack signal 1139 informs the Sys Admin state 1100 and the process continues. If the directory request was for some other operation, for example, generating or updating the contents of the directory, the New Profile? decision 1138 is made. Should the directory service request be to generate a new user profile the Generate New Profile routine 1135 is executed and the process returns to the Directory state 1130. If the directory service request was to update an existing user record, the Update Existing Profile routine 1137 is executed and the process returns to the Directory state 1130. In all cases, once the Directory state 1130 has completed its function, a Directory Ack signal 1139 transfers control back to the Sys Admin state 1100.

The balance of the process associated with the Sys Admin state 1100 consists of handshake signals between other states. The Manage Data signal 1105 is used to pass control to the Acquisition state 1300. When the Acquisition state 1300 has completed its tasks the Active Session signal 1301 informs the Sys Admin state 1100 of the completion. The Serve Active Session signal 1101 is used as discussed above to pass control back to the Idle state 1200. Finally, Error signal 1109 causes the process to enter the Error state 1500 in response to some error condition detected within the Sys Admin state 1100. Error Ack signal 1501 is the return path from the Error state 1500.

The Acquisition state 1300 shown in FIG. 3C is comprised of the User Acquisition state 1320 and the Network Acquisition state 1330. Both of these are looping tasks running in the background and are driven by interrupts from the Acquisition state 1300. Assuming for the moment that a user registered with the system wishes to originate a call, the Originate state 1370 receives an Off Hook signal 1373 indicating that a user is attempting to make a call. Mode Detect step 1375 interrogates the user's device to determine the type of network protocol being used. At Mode Select 1377 the proper source mode is selected and the appropriate network is chosen at Network Protocol Select 1379. The Originate state 1370 then issues a Session Out signal 1371 to the User Acquisition state 1320 which issues a User Interrupt 1321 to the Acquisition state 1300. The Acquisition state 1300 then issues a User Ack 1203 and in turn a Session Out Ack 1327 is issued allowing the outgoing call to proceed.

Assume now that a third party has placed a call to a user registered with the system. In this instance the user's device multi-mode device goes active initiating the Select Network step 1363 in the Receive state 1360. This step interrogates the system to determine the best network over which to establish a communications session. Once the determination is made the user is signaled at Signal User 1365. While this may appear to be backwards—that is with normal communications systems, for example, the PSTN, the user is signaled first—for multi-mode devices the best communications mode is selected before the session is established. The Receive state 1360 then issues a Session In signal 1325 to inform the system that an incoming session is being requested. The User Acquisition state 1320 sends an interrupt as described above and, in turn, a Session In Ack signal 1361 is passed back to the Receive state 1360 allowing the communications session to proceed.

The previous two examples describe how a communications session may be originated or received. These functions are common to contemporary communication networks. One advantage of the present invention is the ability to transfer active sessions between networks “on the fly.” This active session transfer is accomplished by the Transfer state 1350. Suppose that a user is in the middle of a communication session using a multi-mode device such as a cell phone. Suppose further that this device is 802.11 compatible, such as the MMP1 device, 500 of FIG. 1. As the user moves from an area where the wireless cellular signal, for example, a CDMA signal, is not as strong as the 802.11 wireless signal, the Presence Manager module (223 of FIG. 2) sends an interrupt to the Transfer state 1350 via Transfer Int 1323. This interrupt causes the Mode Detect step 1353 to search for the best mode available. At Mode Select 1355 the best mode is selected and at Network Protocol Select 1357 the appropriate network interfaces are selected. The Transfer state 1350 then sends a Transfer Ack 1351 to inform the system that the communications mode switch may be made. This can occur because, running in the background, the Presence Detect routine 1370 and the Update System step 1375 constantly keep the system apprised of which users are present and what network will best serve them.

The Network Acquisition state 1330 is responsible for keeping the system updated regarding the available networks for serving communications sessions. This is a background task that is triggered on a regular basis by the Net Loop interrupt 1305. Network Acquisition state 1330 then polls the networks at Poll Network 1333, detects any available networks at Detect Available Networks 1335, detects network parameters such as signal strength at Detect Network Parameters 1337 and sends the updated data to the Network Acquisition state 1330 via the Send Network Status signal 1339 and on to the system via the Net Status signal 1331.

As with the Sys Admin state 1100, there are a series of signals that pass between the Acquisition state 1300 and other states. The Session Acquired interrupt 1302 is used to pass control to the Call Management state 1400 and the Session Complete interrupt 1401 is used by the Call Management state 1400 to pass control back. In a like manner Active Session interrupt 1301 and Manage Data interrupt 1105 pass control to and from the Sys Admin state 1100. The Go Active interrupt 1206 was discussed above. Finally, the Error interrupt 1309 is used in the same manner as discussed above for the Sys Admin state 1100.

The Call Management state 1400 appears in detail in FIG. 3D. Recall that the Call Management state 1400 is entered via the Session Acquired interrupt 1302 from the Acquisition state 1300. In this state communications sessions in progress are tracked and managed. As with the Acquisition state 1300, there exist an Originate Session state 1470, a Receive Session state 1460 and a Transfer Session state 1450. In addition, there is a Network Monitor state 1480 that monitors the network associated with a particular session to ensure reliable connectivity. In operation, for each particular session in progress there exists a session ID. This session ID is used to send a Resolve Request 1408 to the Network Monitor state 1480. Each time a request is received for a particular session ID, the Check Current Status step 1483 is executed to determine the viability of the network in use as compared to other available networks. At Update Availability 148$5 the status of each of the networks, as it pertains to the specific session ID, is updated. As described above in conjunction with the Acquisition state 1300, these data are used to select the best mode for the particular session. Control is passed back to the Call Management state 1400 via the Resolve Ack signal 1481.

In the case where a user has initiated a session within the Acquisition state 1300, the Call Management state 1400 will issue a Session Request interrupt 1407, passing control to the Originate Session state 1470. Resolve Network Protocol step 1473 determines which active networks are available and at Check Device Compat 1475 the user's device is polled to determine which networks it can communicate over. Once a network communications mode has been selected a session ID is generated at Set Session ID 1479 and control passed back to the Call Management state 1400 via the Session Ready signal 1471. If at any point an error is detected, the Error state 1500 is entered via the Error signal 1477.

Looking now at Receive Session state 1460, if a user's device has been activated by an incoming session request, the Call Management state 1400 is informed via the Session Acquired interrupt 1302, and in turn enters the Receive Session state 1460 via the Session Request signal 1405. In a manner similar to the Originate Session state 1470, the network protocol is resolved at Resolve Network Protocol step 1463, device compatibility checked at Check Device Compat 1465 and a session ID generated at Set Session ID 1469. Once a network communications mode has been selected and a session ID is generated, control passed back to the Call Management state 1400 via the Session Ready signal 1461. If at any point an error is detected, the Error state 1500 is entered via the Error signal 1467.

The Transfer Session state 1450 works in a manner similar to both the Originate Session state 1470 and the Receive Session state 1460. That is, after the Transfer state 1450 has been entered via the Session Request interrupt 1403, the network protocol is resolved at Resolve Network Protocol step 1453, device compatibility checked at Check Device Compat 1455. However, since a session ID has already been set, control is transfered back to the Call Management state 1400 via the Transfer Ack signal 1459, and then to the Call Management state 1400 via the Session Ready signal 1451. If at any point an error is detected, the Error state 1500 is entered via the Error signal 1457.

Two other tasks are accomplished within the Call Management state 1400. These are monitoring session progress of all active sessions and recording an incoming message if the incoming session was not answered. The Monitor Session Progress loop 1404 is responsible for using the session IDs of all active sessions to track call progress and detect abnormal session parameters. For example, but not implying a limitation, the Monitor Session Progress loop 1404 will react to the presence of a dial tone if an incoming call has been dropped. It will be understood that other call progress and status information from both wire-lined and wireless communications networks may be detected and reacted to in a similar fashion without departing from the spirit of the invention. Since this call progress data is well understood it is not discussed in detail here, but a lack of such a detailed discussion should not be read as a limitation on the scope of the invention.

The Record Message step 1402 is used where an incoming call has gone unanswered and the receiving device has a voice message capability. Since this message recording is well understood it is not discussed in detail here, but a lack of such a detailed discussion should not be read as a limitation on the scope of the invention. But by way of example only, in a preferred embodiment of the present invention a portion of the system RAM is set aside for users to enter a brief voice prompt and then to record incoming messages.

The balance of the Call Management state 1400 is comprised of the same type of interrupt and response signals as both the Sys Admin state 1100 and the Acquisition state 1300. Session Complete interrupt 1401 is used to pass control back to the Acquisition state 1300. Error interrupt 1409 is used to inform the Error state 1500 that the Call Management state 1400 has encountered an error that needs to be dealt with. A detailed discussion of the Error state 1500 appears below.

The Error state 1500 appears in detail in FIG. 3E. As described in detail above, the Error state 1500 is entered via an error interrupt, for example, Error interrupt 1109 from the Sys Admin state 1100. Note that the incoming Error interrupt 1109 is exemplary only and could be any error interrupt from any state. Upon entering the Error state 1500 three tasks are performed: error type identification, error analysis and error response generation. Depending upon the exact nature of the error, the system may be able to recover and continue operations. If not, the system is shut down in a controlled manner.

The error type identification takes place in the Type ID state 1520 and is entered via ID Type signal 1503. An error number, generated by the reporting state, is logged at Rcv Error Num step 1523. At Type Look-up step 1525 the number is compared to a table of errors to determine if it is fatal or not. At Fatal? 1527 a decision is made as to the nature of the error. If the error is not fatal the system will be able to recover so control passes back to the Error state 1500 via the ID Ack signal 1521. If the error is fatal the Fatal Error signal 1529 passes control to the Sys Admin state 1100 which then executes a controlled shut down of the system.

Once an error type has been determined the Analysis state 1530 is entered via the Non-Fatal Analysis interrupt 1505. The reported error number is retrieved at Error Number Look-up 1533 and an analysis of the error accomplished at Analysis step 1535. As will be recognized, the exact nature of the analysis will depend on the nature of the error, but in general, reported error numbers and parameters related to the error are considered by the analysis routine. The outcome of the analysis will be a recoverable or non-recoverable state. That decision is made at Recoverable? 1537. If the error is recoverable, an Issue Ack signal 1539 informs the Error state 1500 via the Analyzed Ack signal 1531 which then initiates the recovery process. The Error state 1500 then provides the necessary handshake with the rest of the system to allow the recovery process to proceed. If the error was not recoverable, an Alert to SysAd signal 1538 is sent and control passes to the Sys Admin state 1100 to begin the error logging and reporting procedure. The error reporting and logging procedure is used to provide data for system administrators because, although the error was not fatal, it may be beneficial to understand why the error occurred.

The error recovery process is begun when the Error state 1500 issues a Respond interrupt 1507. Control is passed to the Response state 1540. The Response state 1540 completes a determination of the recovery actions required at Look Up Action 1543. The error is then corrected at Correct Error 1545 and a internal report generated at Generate Report 1547. This report is used later by system administrators to assist in locating faulty or failing components. The Response state sends the Respond Ack interrupt 1541 to the Error state 1500 to complete the recovery process.

From the above detailed discussion of the figures it will be recognized that a first advantage of the method of the present invention is the ability to transfer an active communications session between a plurality of different networks and protocols. This transfer occurs seamlessly and remains hidden to the user, so no user intervention of action is required. Thus a user could originate or receive a call from a third party over a CDMA cellular network, move to an area covered by a more viable 802.11 wireless signal and have the session continue uninterrupted.

A second advantage of the present invention is that it is capable of communicating with a broad variety of network protocols and devices. Thus if the user is in proximity to a cellular network, for example a PCM network, and if that signal is stronger than other signals present at the same time, the user device will take advantage of the stronger signal to transact communication sessions. Likewise, if a user is in an office, the method of the present invention will serve communications sessions over both contemporary and legacy equipments such as iPBX and PBX Centrex switches.

A third advantage of the present invention is that it improves user efficiency and economics. Since there is only one communications server, and since it automatically selects the optimum network for communication sessions, the user is free from the need to program and/or reconnect as the network signals present change. The present invention is economically advantageous since only one server equipment is required, thus only one purchase is required.

A fourth advantage of the present invention is that is provides a platform for future integration of communications functions. This includes moving the PBX or iPBX Centrex switch into the server architecture further improving efficiency and economics.

1. A communications server simultaneously connected to and conversant with a plurality of wire-lined and wireless networks comprising:
a central processing unit;
a network interface unit, and;
a memory to direct operation of a digital device in such a way that said network interface unit, in response to a command from said central processing unit, establishes a communications session via one of a plurality of wire-lined or wireless networks to any of a plurality of communications devices, said plurality of communications devices having been identified to said central processing unit and indicating by a signal which of said plurality of wire-lined or wireless networks is to be used for a particular communications session.

2. The communications server of claim 1 where the plurality of networks includes at least a wire-lined network, a wireless cellular telephone network and a wireless local area network.

3. The communications server of claim 2 wherein;
the wire-lined network is the Public Switched Telephone network;
the wireless cellular telephone network is one or more of a CDMA, PCM, TDMA or analog wireless cellular telephone network, and;
the wireless local area network is a 802.11 wireless network.

4. The communications server of claim 1 wherein the a private branch exchange, an internet private branch exchange and a mobile switching center are integrated into said communications server.

5. The communications server of claim 1 where said communications server is capable of transacting data types of text, voice and graphics.

6. A communications server simultaneously connected to and conversant with a plurality of wire-lined and wireless networks comprising:
a central processing unit;
a network interface unit, and;
a memory to direct operation of the communications server such that said memory cooperates with a single wireless user communications device having been identified with said communications server and configured to communicate with any of said plurality of networks connected to said communications server at any time such that after having been contacted by a specific one of said plurality of networks and having established a communications session the signal of said specific one of said plurality of networks becomes less reliable than the signal of a second one of said plurality of networks, said communications server and said single wireless user communications device cooperating to transfer said established communication session from the first specific one of said plurality of networks to the second one of said plurality of networks without the knowledge of the user and without disrupting said established communication session.

7. A memory to direct operation of a communications server simultaneously connected to and conversant with a plurality of wire-lined and wireless networks comprising at least:
a presence manager module;
a personal profile and call manager module;
a directory services module;
a media processing manager module;
a message services manager module, and;
a network interface manager module interoperably connected in such a way as to establish a communications session via one of a plurality of wire-lined or wireless networks to any of a plurality of communications devices, said plurality of communications devices having been identified to the communications server and indicating by a signal which of said plurality of wire-lined or wireless networks is to be used for a particular communications session.
